(19) United States
(12) Patent Application Publication
(10) Pub. No.: US 2009/0021690 A1
(43) Pub. Date: Jan. 22, 2009

(54) RIMLESS EYEWEAR ASSEMBLY

(76) Inventors: Ira S. Lerner, New York, NY (US); Reniel Agusto, San Antonio, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/125,404

(22) Filed: May 22, 2008

Related U.S. Application Data
(60) Provisional application No. 60/939,973, filed on May 24, 2007.

(51) Int. Cl. G02C 1/02

(52) U.S. Cl. 351/110

(57) ABSTRACT

Eyewear comprises a lens. The lens comprises a viewing portion and a connecting portion. The lens comprises a peripheral surface. The viewing portion of the lens is defined inside of the peripheral surface of the lens and the connecting portion of the lens is defined outside of the peripheral surface of the lens. The connecting portion of the lens comprises a mounting bore. An eyewear frame member covers at least a portion of the connecting portion of the lens and an eyewear frame connecting member extends through a portion of the eyewear frame member and into the mounting bore of the connecting portion of the lens such that the eyewear frame member is secured to the connecting portion of the lens by the eyewear frame connecting member.

### CROSS-REFERENCE TO RELATED APPLICATIONS

This application claims the priority benefit under 35 U.S.C. § 119(e) of U.S. Provisional Patent Application No. 60/939,973, filed May 24, 2007, which is incorporated by reference in its entirety.

### BACKGROUND OF THE INVENTION

1. Field of the Invention

The present invention generally relates to spectacles and eyeglasses. More particularly, the present invention relates to rimless mounting of lenses in spectacles and eyeglasses.

2. Description of the Related Art

Eyewear generally comprises two lenses that are connected by a bridge and two temples that extend rearward from a lens connection location to the ears of a user. Most eyewear over time has featured a frame that generally encircled each of the lenses. Recently, rimless constructions have been designed.

One rimless construction is a so-called three piece mount. A three piece mount features a bridge and two temples that are fastened to a front or rear surface of the lens. In other words, the bridge and temples are secured using fasteners that extend through the lens. To use such a configuration, holes or slots must be formed in the lens. Such a construction can be difficult to construct due to the need to form the holes or slots. Moreover, such a construction obscures a portion of the lens through which a wearer may attempt to look, and may also cause distortion and cracks (often referred to as “starcracks”) within the viewing portion of the lens. Accordingly, such a construction is less desired.

In addition, so-call three piece mounts generally require two holes, notches or slots to attach each temple or bridge to each lens in order to reduce the likelihood of accidental rotation of the temples or bridge that may occur if only one hole or slot is used for each connection. Such a construction is disadvantageous because it requires a total of eight holes, notches or slots to attach both lenses to the bridge and temples. Accordingly, a construction is desired that involves fewer holes, notches or slots and that positions such features outside of the viewing area.

Moreover, constructions are known in which a clamp grips a portion of the peripheral edge of the lens. See, for example, U.S. Pat. No. 4,895,438. Such a construction still obscures a portion of the lens through which a wearer may attempt to look. Moreover, the clamping construction is complicated and difficult to work with.

Zider et al. (U.S. Pat. No. 6,164,775) disclosed a construction in which projections were formed on the lenses and those projections were gripped by an attachment member through direct gripping or through a vertical sliding motion. The desired effect was to provide lenses that were easily changed and adjusted without the use of structural rims, cords or screws. While such a configuration may be useful in select circumstances, the resulting eyewear is not sturdy enough for day to day use. Moreover, having eyewear in which the lenses are not securely mounted can frustrate the wearers of prescription eyewear.

### SUMMARY OF THE INVENTION

Thus, a need exists for a rimless eyewear construction that is simple to assemble, that is secure when assembled and that provides connection locations for the basic components outside of the viewing portion of the lenses.

One aspect of some embodiments of the present invention involves eyewear that comprises a first lens. The first lens comprises a first bridge connecting portion, a first viewing portion and a first temple connecting portion. The first viewing portion comprises a first peripheral surface. The first bridge connecting portion extends outward from the first peripheral surface. The first temple connecting portion extends outward from the first peripheral surface. A first bore extends into the first temple connecting portion. A second lens comprises a second bridge connecting portion, a second viewing portion and a second temple connecting portion. The second viewing portion comprises a second peripheral surface. The second bridge connecting portion extends outward from the second peripheral surface. The second temple connecting portion extends outward from the second peripheral surface. A second bore extends into the second temple connecting portion. A bridge covers at least a portion of the first bridge connecting portion and is secured to the first bridge connecting portion. The bridge also covers at least a portion of the second bridge connecting portion and is secured to the second bridge connecting portion. A first temple covers at least a portion of the first temple connecting portion and is secured to the first temple connecting portion by a first member that extends into the first bore. A second temple covers at least a portion of the second temple connecting portion and is secured to the second temple connecting portion by a second member that extends into the second bore.

Another aspect of some embodiments of the present invention involves eyewear comprising a lens. The lens comprises a viewing portion and a connecting portion. The lens comprises a peripheral surface with the viewing portion of the lens being defined inside of the peripheral surface of the lens and the connecting portion of the lens being defined outside of the peripheral surface of the lens. The connecting portion of the lens comprises a mounting bore. An eyewear frame member covers at least a portion of the connecting portion of the lens and an eyewear frame connecting member extends from a portion of the eyewear frame member and into the mounting bore of the connecting portion of the lens such that the eyewear frame member is secured to the lens by the eyewear frame connecting member and the connecting portion of the lens.

### BRIEF DESCRIPTION OF THE DRAWINGS

These and other features, aspects and advantages of the present invention will now be described with reference to the drawings of several preferred embodiments. The embodiments are intended to illustrate and not to limit the invention.

FIG. 1 is a perspective view of eyewear that is arranged and configured in accordance with certain features, aspects and advantages of the present invention.

FIG. 2 is an enlarged exploded perspective view of the eyewear of FIG. 1.

FIG. 3 is a partially sectioned top view of the eyewear of FIG. 1.

FIG. 4 is a rear perspective view of a portion of the eyewear of FIG. 1.

FIG. 5 is a partially sectioned front view of a portion of the eyewear of FIG. 1.

FIG. 6 is an exploded perspective view of another embodiment of eyewear that is arranged and configured in accordance with certain features, aspects and advantages of the present invention.

FIG. 7 is a perspective view of the eyewear of FIG. 6.

FIG. 8 is a partially sectioned front view of a portion of the eyewear of FIG. 6.

FIG. 9 is a partially sectioned front view of a portion of another embodiment of eyewear that is arranged and configured in accordance with certain features, aspects and advantages of the present invention.

FIG. 10 is a partially sectioned front view of a portion of a further embodiment of eyewear that is arranged and configured in accordance with certain features, aspects and advantages of the present invention.

FIG. 11 is a partially sectioned front view of a portion of an embodiment of eyewear that is arranged and configured in accordance with certain features, aspects and advantages of the present invention.

FIG. 12 is a section taken along the line 12-12 in FIG. 11.

FIG. 13 is an exploded perspective view of another embodiment of eyewear that is arranged and configured in accordance with certain features, aspects and advantages of the present invention.

FIG. 14 is a sectioned side view of a portion of the eyewear of FIG. 13.

FIG. 15 is an exploded perspective view of an embodiment of eyewear that is arranged and configured in accordance with certain features, aspects and advantages of the present invention.

FIG. 16 is a sectioned side view of a portion of the eyewear of FIG. 15.

FIG. 17 is a perspective view of another embodiment of eyewear that is arranged and configured in accordance with certain features, aspects and advantages of the present invention.

FIG. 18 is a sectioned side view of a portion of the eyewear of FIG. 18.

FIG. 19 is an exploded perspective view of another embodiment of eyewear that is arranged and configured in accordance with certain features, aspects and advantages of the present invention.

FIG. 20 is a perspective view of a portion of the eyewear of FIG. 19.

FIG. 21 is a sectioned view of the eyewear of FIG. 19 taken along the line 21-21 in FIG. 20.

FIG. 22 is a sectioned view of another embodiment of eyewear that is arranged and configured in accordance with certain features, aspects and advantages of the present invention.

FIG. 23 is a rear perspective view of a portion of a temple member that is arranged and configured in accordance with certain features, aspects and advantages of the present invention.

FIG. 24 is a sectioned view taken along the line 24-24 in FIG. 23.

FIGS. 25 and 26 are views similar to that of FIG. 24 showing varied post structures and fasteners.

FIG. 27 is a rear perspective view of a portion of a bridge member that is arranged and configured in accordance with certain features, aspects and advantages of the present invention.

### DETAILED DESCRIPTION OF THE PREFERRED EMBODIMENT

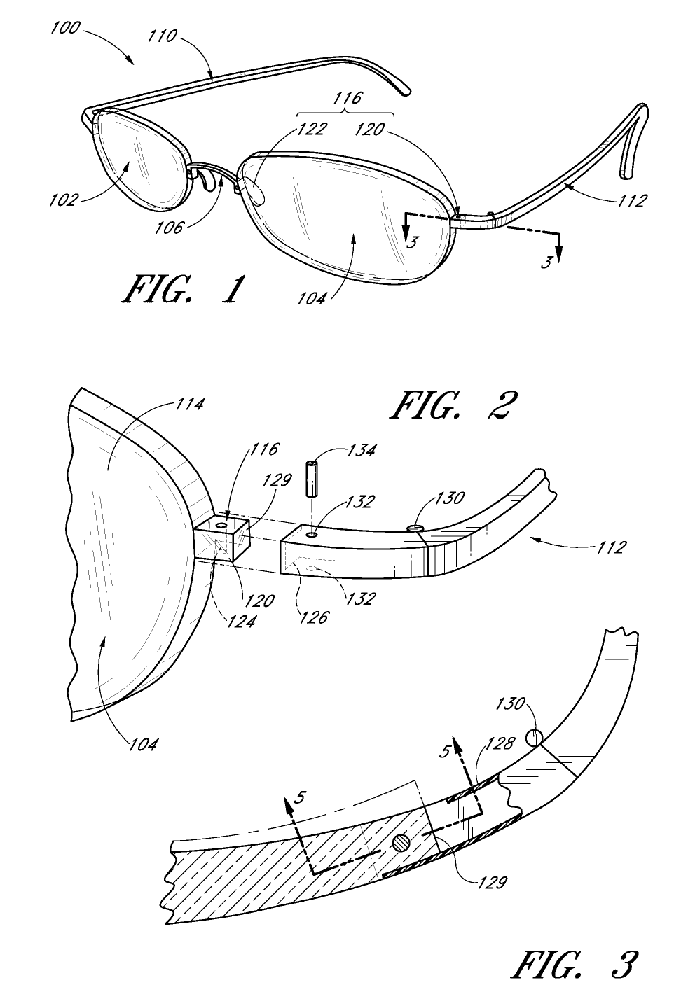

FIGS. 1-5 illustrate an embodiment of eyewear 100 that is arranged and configured in accordance with certain features, aspects and advantages of the present invention. The eyewear 100 generally comprises a first lens 102 and a second lens 104. A bridge 106 connects the first lens 102 to the second lens 104. A first temple 110 preferably extends from the first lens 102 and a second temple 112 preferably extends from the second lens 104. Generally speaking, the temples 110, 112 fit against a user's ears.

With reference now to FIG. 2, in the illustrated configuration, each of the lenses 102, 104 comprises a viewing portion 114 and a connecting portion 116. The lenses 102, 104 can be formed from glass. In some configurations, the lenses can be formed from a polymer material, such as a polycarbonate, which is used in the manufacture of eyewear lenses.

The viewing portion 114 and the connecting portion 116 preferably are integrally formed by, for example, molding or machining or a combination of suitable manufacturing steps. Such integrally forming results in a monolithic construction. While less desirable from a strength and durability standpoint, in some embodiments, it is possible for the connecting portion 116 to be formed separately from the viewing portion 114 and then bonded to the viewing portion 114. In a preferred configuration, the connecting portion 116 is defined relative to the viewing portion 114 such that a line connecting the outer edge of the viewing portion 114 at two junctures between the connecting portion 116 and the viewing portion 114 separates the connecting portion 116 from the viewing portion 114. In other words, the lens generally has a peripheral (e.g., side) surface and the connection portion 116 extends outward from the peripheral surface.

A user of the eyewear 100 can see through the viewing portion 114 while the connecting portion 114 is positioned outside of the viewing portion 114 to reduce the likelihood of the connecting portion 114 obscuring the view through the viewing portion 114 when the eyewear is assembled. In the illustrated configuration, the connection portion 116 can comprise a temple connecting portion 120 and a bridge connecting portion 122. In other words, the connection portion 116 comprises at least two separate and distinct portions with the viewing portion 114 being at least partially positioned between two of those separate and distinct portions of the connecting portion 116.

While the illustrated construction features the temple connecting portion 120 and the bridge connecting portion 122, in some constructions, at least one of the first and second lenses 102, 104 can be provided with only one connecting portion 116. In such a construction, the connecting portion 116 can be positioned such that it connects to a frame member, such as a brow bar, for example but without limitation. The frame member, in such a configuration, can function as one or more of the bridge and the temples.

With reference to FIG. 2, the illustrated temple connecting portion 120 has a generally cubic configuration. Other configurations are possible. The illustrated construction has an advantage in that it is more easily formed than other configurations, such as cylinders or the like. In some configurations, including the configuration illustrated in FIG. 2, the connecting portion 120 has a thickness that is substantially the same as the thickness of the adjacent viewing portion 122 of the respective lens 102, 104.

Preferably, in the configuration shown in FIG. 2, the connecting portion 120 comprises a bore 124 or other suitable opening. While the illustrated bore 124 extends completely through the associated connecting portion 120, the bore 124 can extend only part way through the connecting portion 120. In addition, while the illustrated bore 124 extends in a generally vertical orientation, the bore 124 can have other orientations. The generally vertical orientation, however, obscures the presence of the bore from line of sight of people viewing the eyewear, which improves the aesthetics of the eyewear.

As shown in FIG. 2, the temple 112 preferably has a recess 126 or other hollow construction formed at an end that will couple to the associated lens 104. The recess 126 can be defined by three or four walls. For instance, in some configurations, the recess 126 is defined by an upwardly facing wall, a forward facing wall and a downwardly facing wall. In such a configuration, the recess 126 is open in a rearward direction as well as in the direction of the lens 104. In other words, a rearward facing wall 128 can be omitted or can terminate a distance away from the peripheral wall of the lens 114 that is greater than an outer surface 129 of the connecting portion. By terminating one of the walls such that an open recess is defined, the temple 112 can be used with connecting portions 116 of varying thicknesses, which varying thicknesses can result from different lens thicknesses or prescriptions.

A less desired configuration can be formed wherein the recess 126 is defined by four walls. Such a configuration is less desired because the position of the connecting portion 120 within the recess 126 described above can be more easily adjusted without the rearward facing wall. Nevertheless, it is possible to form the recess with four outwardly exposed walls. Moreover, it is possible to form the recess 126 with one or two walls and, in some configurations, to have the connecting portion 120 in combination with the temple 112 define a hinge-like structure (e.g., the connecting portion 120 defines one portion of the hinge structure while the temple defines the second portion of the hinge structure) although such a configuration is likely to be less durable than positioning a hinge along the temple 112 as illustrated.

With prescription lenses, due to requirements relating to the angular orientation of some prescriptions, if the recess 126 is defined by a single wall, the wall and the connecting portion preferably are joined in a manner that reduces the likelihood of the wall and the connecting portion pivoting with respect to each other. For example, a pair of spaced apart pins or screws can substantially fix an angular orientation of the temple and the lens or of the bridge and the lens. In some embodiments, a hole and notch can be provided in the connecting portion to reduce the likelihood of rotation among the components. Advantageously, when the recess 126 is defined by two or more walls, the lenses, temples and bridges are less likely to move significantly relative to each other and the angular orientations among the components are more likely to be maintained.

The temple 112 preferably comprises one or more openings 132. The openings 132 can define a passage through which a pin 134 can extend. The pin 134 extends through or into the first opening 132, through the bore 124 and through or into the second opening 132. The pin 134 couples the temple connecting portion 120 to the temple 112. In some configurations, the bore 124 formed in the temple connecting portion 120 has an inner diameter that is slightly larger than an outer diameter of the pin 134. In some configurations, at least one of the openings 132 has an inner diameter that is substantially the same as, or slightly smaller than, the outer diameter of the pin 134 such that the pin 134 and the opening 132 have an interference or force fit interface. In some configurations, the pin 134 is secured within the opening 132 or openings 132 through a suitable manner, including but not limited to adhesion, cohesion, welding, brazing, threaded members, force fit, interference fit, and the like.

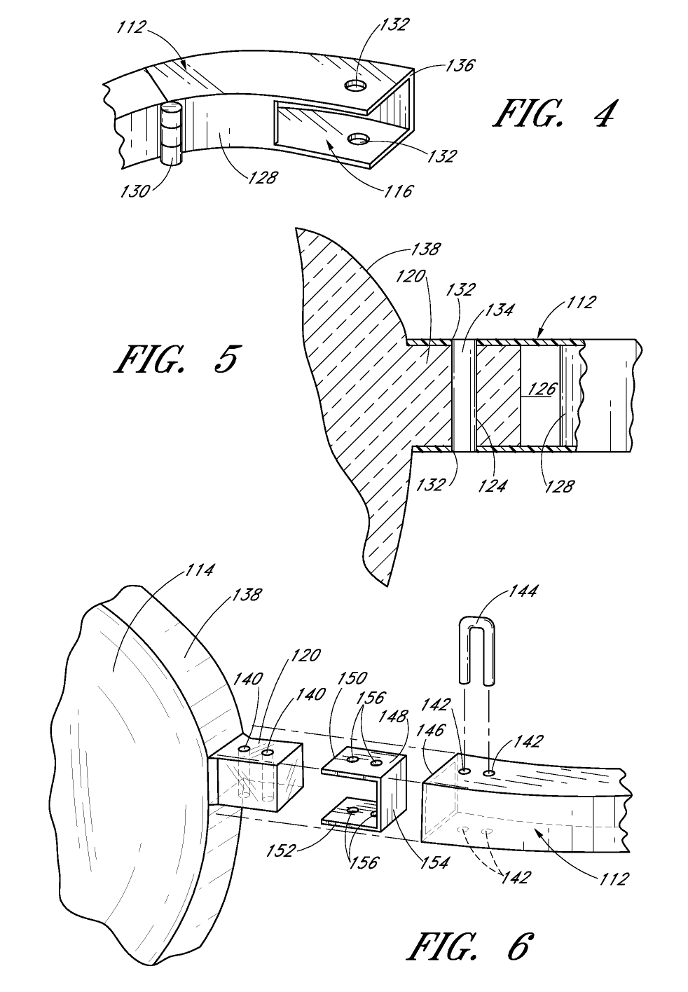

With reference to FIG. 5, preferably the centerline of the openings 132 is spaced from an end 136 of the temple 112 a distance that generally corresponds to a distance between a peripheral surface 138 of the lens 102, 104 and a centerline of the bore 124. Thus, the end 136 of the temple 112 preferably generally abuts, or is spaced very slightly from, the peripheral surface 138 of the lens 102, 104.

While the illustrated eyewear 100 have been disclosed by describing a coupling configuration between the temple 112 and the temple connecting portion 120, the same coupling configuration also can be used to join the bridge 106 to the bridge connecting portion 122 of each lens. Thus, the same reference numerals for the bore 124, the openings 132, the pin 134 and the other related components also refer to components used to connect the bridge 106 to the bridge connecting portion 122.

When assembling the eyewear 100, the lenses 102, 104 first are prepared. Preferably, each lens 102, 104 is prepared to define the viewing portion 114 and the connecting portion 116. In some embodiments, the connecting portion 116 comprises the temple connecting portion 120 and the bridge connecting portion 122. The bridge connecting portions 122 of the two lenses 102, 104 can be connected together with the bridge 106 by securing pins 134 within the respective openings 132 and bores 124. Thus, the bridge can join together the first and second lenses 102, 104. The temples 110, 112 can be secured to the temple connecting portions 120 of the respective lenses 102, 104 by securing the pins 134 within the respective openings 132 and bores 124. Thus, the temples and bridges can be simply and securely coupled to the lenses 102, 104.

FIGS. 6 and 7 illustrate another embodiment that is arranged and configured in accordance with certain features, aspects and advantages of the present invention. To simplify the description, components described above will continue to use the same reference numeral and those components will not be further described herein.

As illustrated in FIG. 6, rather than comprising a single bore 124 and a single pin 134 in each connecting portion 120, the connecting portions can comprise at least two bores 140. In the illustrated configuration, the connecting portion 120 that is illustrated is the temple connecting portion 120 and the temple connecting portion 120 comprises two bores 140. Providing two bores along the connecting portion improves the rigidity of the mounting and reduces wear and tear that may result from micromovements of the temple or bridge relative to the lens. While the illustrated bores 140 extend completely through the associated connecting portion 120, the bores 140 can extend only part way through the connecting portion 120. In addition, while the illustrated bores 140 extend in a generally vertical orientation, the bores 140 can have other orientations.

The temple 112 illustrated in FIG. 6 preferably comprises an upper pair of openings 142 and a lower pair of openings 142. The openings 142 are paired to define a passage through which a U-shaped pin 144 can extend. While the illustrated pin 144 comprises a U-shaped configuration, the pin 144 can be replaced by two separate pins in some configurations. The pin 144 preferably extends through or into the upper openings 142, through the bores 140 and through or into the lower openings 142. The pin 144 couples the temple connecting portion 120 to the temple 112. In some configurations, the bores 140 formed in the temple connecting portion 120 have an inner diameter that is slightly larger than an outer diameter of the associated leg of the pin 144. In some configurations, at least one of the openings 142 has an inner diameter that is substantially the same as, or slightly smaller than, the outer diameter of the associated leg of the pin 144 such that the pin 144 and the opening 142 have an interference or force fit interface. In some configurations, the pin 144 is secured within the opening 142 or openings 142 through a suitable manner, including but not limited to adhesion, cohesion, welding, brazing, threaded members, force fit, interference fit, and the like.

With reference to FIG. 5, preferably the centerline of each of the openings 142 is spaced from an end 146 of the temple 112 a distance that generally corresponds to a distance between a peripheral surface 138 of the lens 102, 104 and a centerline of the respective bore 144. Thus, the end 146 of the temple 112 preferably generally abuts, or is spaced very slightly from, the peripheral surface 138 of the lens 102, 104.

FIG. 5 also illustrates a reinforcing member 148. The reinforcing member 148 is sized and configured to be positioned between at least a portion of the connecting portion 120 and the member connected to the connecting portion (e.g., the temple 112 or the bridge 106). In particular, the illustrated reinforcing member 148 can slip over at least a portion of the connecting portion 116. In some configurations, the reinforcing member is sized and configured to extend along the connecting portion 116 such that it substantially abuts upon the peripheral surface 138 of the associated lens 102, 104.

The illustrated reinforcing member comprises an upper wall 150, a lower wall 152 and a side wall 154 that extends between at least a portion of the upper wall 150 and the lower wall 152. In some embodiments, the reinforcing member can be a single plate without any bends and can simply overlie at least a portion of a wall of the connecting portion 116. At least one opening 156, and preferably at least two openings 156, are defined through each of other upper wall 150 and the lower wall 152 in the illustrated embodiment. The openings preferably correspond in location with the bores 140 and the openings 142 formed in the temple 112 or bridge 106. As such, in some embodiments, any openings may extend through only one wall of the reinforcing member.

In assemblies featuring the reinforcing member 148, the openings 156 of the reinforcing member or the openings 142 in the member (e.g., the temple 112 or the bridge 106), or both, can have a smaller inner diameter than the inner diameter of the passage. More preferably, in some assemblies featuring the reinforcing member 148, the openings 156 in the reinforcing member 148, the openings 142 in the associated member (e.g., the temple 112 or the bridge 106), or both, can have a smaller inner diameter than an outer diameter of the associated pin 144. In such a manner, the pin 144 can be secured in place through interference between the respective inner and outer surfaces.

In some configurations, the pin 144 is secured in position relative to the bores 140 through a suitable manner, including but not limited to adhesion, cohesion, welding, brazing, threaded members, force fit, interference fit, and the like. With reference now to FIG. 8, the pin 144 also can be provided with caps 160 or can be deformed to have enlarged ends once the pin 144 is positioned within the bores 140. In some configurations, the pin 144 can have hollow legs such that the caps 160 can be provided with posts that can be secured within the hollow legs of the pin 144. In some configurations, the caps 160 can be secured over portions of the legs of the pin 144 that extend beyond the outer surface of the associated member (e.g., the temple 116 or the bridge 106).

While the illustrated eyewear 100 have been disclosed by describing a coupling configuration between the temple 112 and the temple connecting portion 120, the same coupling configuration also can be used to join the bridge 106 to the bridge connecting portion 122 of each lens. Thus, the same reference numerals for the bore 124, the openings 132, the pin 134 and the other related components also refer to components used to connect the bridge 106 to the bridge connecting portion 122.

FIG. 9 shows a construction in which the pin 144 has been replaced by two shorter unshaped clips 162. The clips 162 each feature two legs and a bight portion that connects the two legs. In the illustrated configuration, the two legs are substantially shorter than one half of the total height of the temple 112 or bridge 106 such that, when the two clips 162 are installed in position, a space 164 is defined between the legs of the two clips 162.

Similar to the constructions described above, the openings 156 of the reinforcing member or the openings 142 in the member (e.g., the temple 112 or the bridge 106), or both, can have a smaller inner diameter than the inner diameter of the passage. More preferably, in some assemblies featuring the reinforcing member 148, the openings 156 in the reinforcing member 148, the openings 142 in the associated member (e.g., the temple 112 or the bridge 106), or both, can have a smaller inner diameter than an outer diameter of the legs (or at least the relevant portion of the legs) of the clips 162. In such a manner, the clips 162 can be secured in place through interference between the respective inner surface of the openings and the outer surfaces of the clips 162.

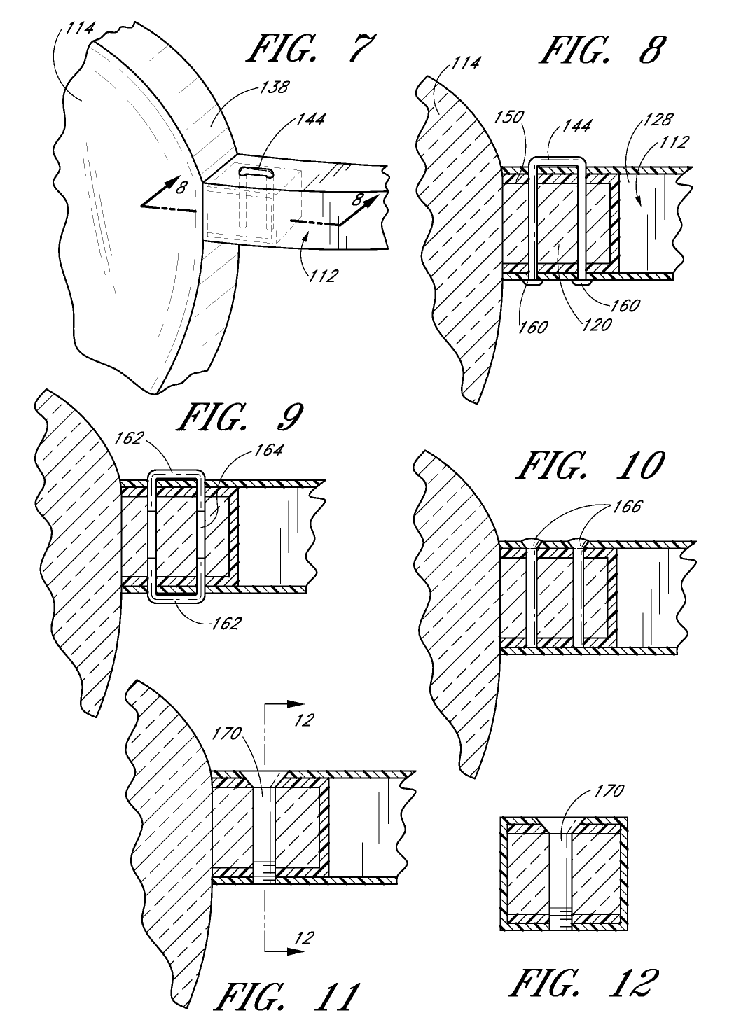

FIGS. 10-12 illustrate additional manners of joining the frame member (e.g., the temple 112 or the bridge 106), the reinforcing member 148 and the connecting portion 116. FIG. 10 illustrates two pins 166 that can be used. In some configurations, at least one of the pins 166 can be threaded such that it engages with one or more surface of the assembly. In some configurations, threads on at least one of the pins 166 can engage with an internally threaded surface formed in the reinforcing member 148. Such a configuration enables the reinforcing member 148 to be replaced if the threads fail in the reinforcing member or if there is some imperfection in the threads.

FIG. 11 shows a construction in which only one bore 124 is provided, similar to the construction of FIG. 1, while a reinforcing member 148 also is provided and a single pin 170 is provided. As described directly above, the pin 170 can engage with one or more surface of the assembly. As described above, the pin 170 can be secured in position relative to the bore 124 through a suitable manner, including but not limited to adhesion, cohesion, welding, brazing, threaded members, force fit, interference fit, and the like.

With reference now to FIGS. 13 and 14, a construction is illustrated in which the temples 112 are connected to the lenses 102, 104 with a generally horizontally extending fastener 180. Thus, the connecting portion 120 comprises a generally horizontally extending hole. Providing a generally vertically extending hole may weaken the connecting portion 120 of the lens or require a thicker connecting portion in order to accommodate the hole and provide sufficient material thickness surrounding the hole for the connecting portion to be durable enough for everyday use and, therefore, providing the hole in a generally horizontally extending configuration can result in a stronger and more durable construction.

While the illustrated configuration shows the temple 112 being connected to the lens 102, 104 at the temple connecting portion 120, a similar configuration can be used to connect the bridge to the bridge connecting portion 122. As illustrated, the recess 126 of the illustrated temple 126 fits over the connecting portion 116 (i.e., the temple connecting portion 120 or the bridge connecting portion) and preferably slides over at least a portion of a forward facing surface of the connecting portion 116. A reinforcing member 182 can slide over at least a portion of at least a rearward facing surface of the connecting portion 116. The illustrated reinforcing member 182 can telescope relative to the temple 112 such that connecting portions of varying thicknesses can be accommodated by the assembly (see the dotted lines in FIG. 14). Together, the reinforcing member 182 and the member (i.e., the temple 112 or the bridge 106) wrap around at least portions of the top surface, the bottom surface, the front surface and the back surface of the connecting portion 116.

While the illustrated reinforcing member 182 in positioned between the connecting portion 116 and the associated member (i.e., the temple 112 or the bridge 106), it is possible to have the associated member positioned between the connecting portion 116 and the reinforcing member 182. In other words, it is possible to have the reinforcing member 182 positioned over an otherwise outer surface of the associated member. Moreover, while the illustrated reinforcing member 182 covers a rear surface of the connecting portion 116, it is possible to have the reinforcing member 182 cover a forward surface of the connecting portion while the opening defining the recess 126 opens through a forward surface of the temple 116 or bridge 106. Further, in some configurations, the associated member (i.e., temple 112 or bridge 106) does not have a recess that extends through a wall of the associated member such that the associated member itself encloses the connecting portion 116 and the reinforcing member 182 can extend over at least a portion of as few as one surface or as many as five surfaces of the connecting portion 116.

With reference again to FIG. 13, the fastener 180 can be secured in position in any suitable manner, including but not limited to adhesion, cohesion, welding, brazing, threaded members, force fit, interference fit, and the like. In the illustrated configuration, the fastener 180 comprises ridges or barbs instead of threads. In the illustrated configuration of FIG. 13, a nut 184 can be provided. Thus, the illustrated fastener 180 can be inserted into the nut 184 and the two members 180, 184 can secure the assembly together when the nut 184 and the barbs engage.

In some embodiments, a compression mounting can be used to couple the member (i.e., the temple 112 or the bridge 106) to the connecting portion 116. The compression mounting can use a fastener that is cut to length after assembly and a snap fit cap can be placed over the cut fastener (i.e., the cap can be forced over a barb or ridge of the fastener) to secure the assembly. In some constructions a threaded fastener can be used.

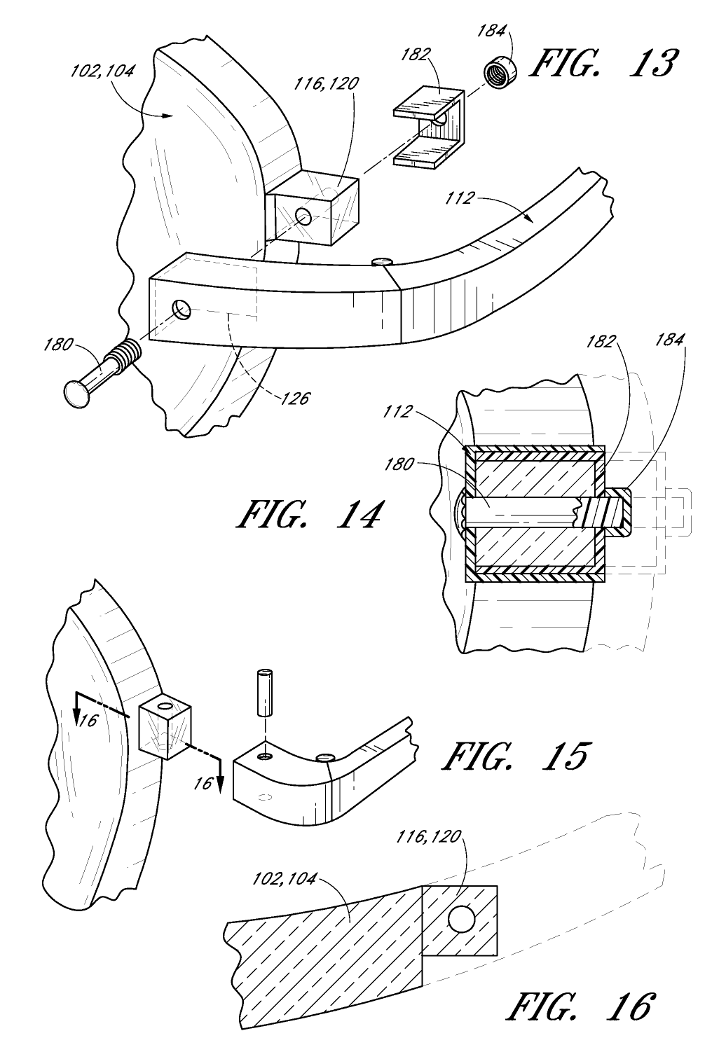

FIGS. 15 and 16 illustrate a construction similar to that shown in FIGS. 1-5 and described above. In the configuration of FIGS. 15 and 16, the connecting portion 116 (i.e., the temple connecting portion 120 or the bridge connecting portion 122) is formed such that the connecting portion 116 generally has a consistent thickness. In other words, regardless of what prescription is being used and/or regardless of the thickness of the lens, the connecting portion 116 has a predetermined thickness such that a standard size can be provided to the temple 112 or the bridge 106. The lenses, however, should maintain a minimum edge thickness such that the smallest size of the temple 112 and the reinforcing member 148 can maintain a secure connection with the connecting portion 116. Moreover, as shown, the connecting portion 116 can be formed such that the connecting portion 116 extends at an angle relative to the curvature of the associated lens 102, 104. By forming the connecting portion 116 in this manner, the bend at the end of the temple 112 can be standardized for use with any lens, regardless of the curvature of the lens.

In some configurations, the connecting portion 116 can be formed such that at least one surface of the connecting portion 116 is flush with a rearward or forward surface of the associated lens 102, 104. For example, in the illustrated configuration, the rearward surface of the connecting portion 116 extends from the rearward surface of the lens 102, 104. In some configurations, however, the connecting portion 116 can extend outward from a more central portion of the lens 102, 104. Other configurations also are possible.

The connecting portion 116 can be formed such that the connecting portion 116 curves. In some embodiments, the curve of the connecting portion 116 continues the base curve of the lens. Such a configuration is shown, for example, in FIG. 3. This construction is advantageous because the connecting portion 116 of the lens is generally continuous with the prescriptive portion of such lenses and can have any suitable thickness.

In some embodiments, however, the connecting portion 116 can be formed such that the connecting portion 116 does not follow the base curve of the lens. Such a configuration is shown, for example, in FIG. 16. This construction is advantageous because the connecting portions 116 of the lens can be made in such a way that it has a generally uniform cross section, regardless of the prescription of the lens, which allows the standardization of various components of the eyewear.

In some embodiments, the connecting portion 116 can be cut such that the connecting portion 116 is generally perpendicular to the axis of the base curve of the lens. Such a configuration is shown, for example, in FIG. 16. This construction is advantageous because the connecting portions 116 of the lens can be made uniform in size and curve, which allows the standardization of various components of the eyewear. Moreover, such a construction allows a four sided or fully enclosed sleeve to slide over the connecting portions.

The embodiment of FIGS. 17 and 18 show a temple 212 that is flush mounted to at least a portion of a connecting portion 216. The illustrated temple 212 mounts flush to a front surface of the connecting portion 216, which can be a temple connecting portion 220. In some embodiments, the temple 212 can mount to a top, back, bottom or side surface of the connecting portion 216. Other configurations also are possible.

The illustrated configuration uses two pins 234 to join the temple 212 to the connecting portion 220. The pins 234 can be secured in position relative to the temple 212 and the connecting portion 220 through a suitable manner, including but not limited to adhesion, cohesion, welding, brazing, threaded members, force fit, interference fit, and the like. In some configurations, a reinforcing member (not shown) can be used with the simple temple 212 of FIGS. 17 and 18. The reinforcing member can be a simple plate or can extend over two or more surfaces of the connecting portion 220.

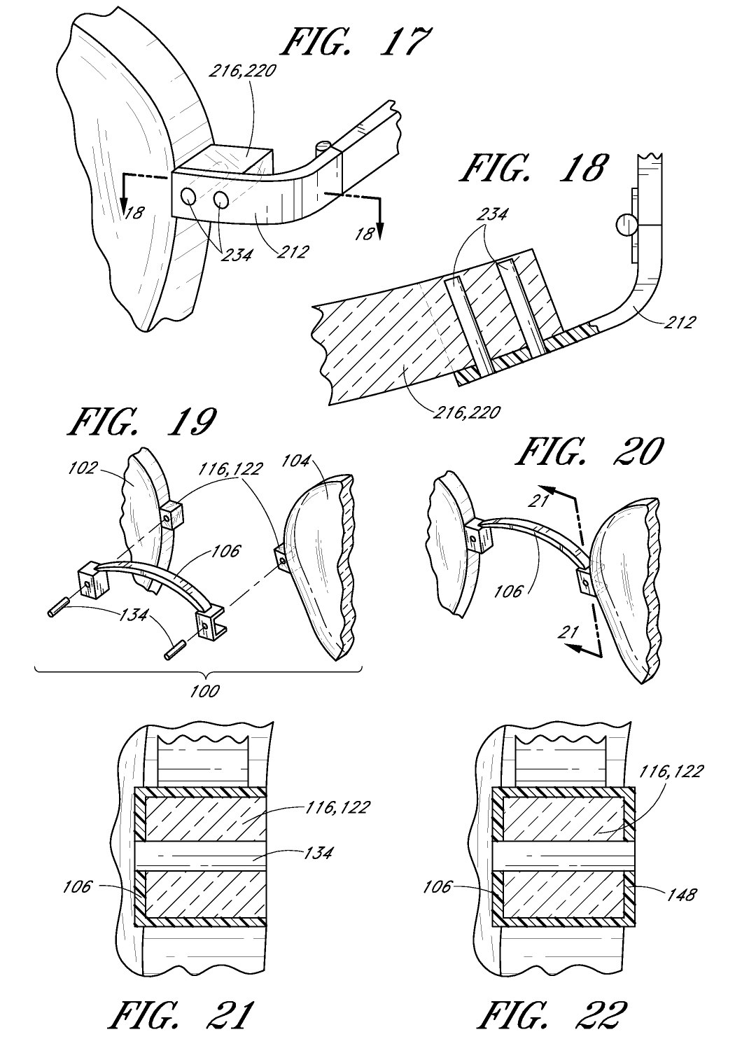

For clarity, FIGS. 19-22 illustrated the bridge 106 and some mounting configurations in the context of the bridge 106. For example, FIGS. 19-21 illustrate the bridge 106 in which the bridge has a recess formed by three walls while FIG. 22 illustrates the bridge 106 in which the bridge has a recess formed by four walls. As discussed above, any of the mounting assemblies described above in the context of the temple 212 can be used in the context of the bridge 106. For simplicity and brevity, a repeat of the entire description of each of the mounting assemblies has not been made but the descriptions set forth above should be understood to apply not only to temples, but also to bridges.

FIGS. 23-26 illustrated additional configurations. As illustrated, temple members 312 can be provided with integrated mounts 313. As illustrated, the integrated mounts 313 can extend in a generally horizontal direction. The mounts 313, however, can extend in any other desired direction. By integrally or monolithically forming the mounts 313 with the temple member 312, and more particularly, by integrally or monolithically forming the mounts 313 with an inside surface of the illustrated temple member, there is no visible mount to be viewed from the outside of the top, bottom or front surfaces of the eyewear. Such a construction, therefore, is cosmetically and aesthetically more desirable.

The mounts 313 can have any suitable construction. In some embodiments, the mounts 313 can comprise one or more pins 315 (see FIGS. 23 and 24). The pins 315 can be generally cylindrical in construction. In some embodiments, the pins 315 have a noncylindrical shape (e.g., an oval cross section, a square cross section or some other cross section that will reduce the likelihood of relative rotation between the lens and the temple member 312). The mounts 313 can be secured in place in any suitable manner. In some configurations, the mounts 313 are secured to the lenses with threads, glues, press fits, adhesives, cohesives and the like.

In some embodiments, the mounts 313 can comprise a threaded portion 317 (see FIG. 25). The threaded portion 317 preferably is sized and configured to extend beyond the lens such that a nut 319 or some other threaded member can secure the lens in position relative to the temple member 312. In some embodiments, the mounts 313 can comprise a barbed portion 321. The barbed portion 321 preferably is sized and configured to extend beyond the lens. In some configurations, the barbed portion 321 can secure the lens in position itself while, in other configurations, the barbed portion 321 can receive a cap 323 such that the cap 323 and the mount 313 can define a compression fitting. Other mount configurations also can be used.

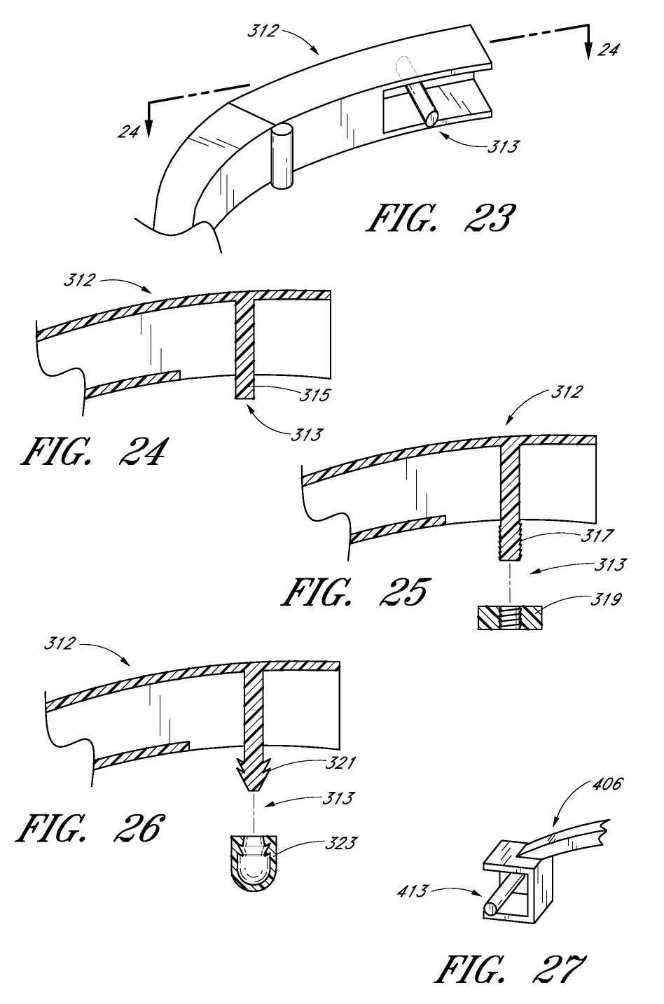

For clarity, FIG. 27 illustrates another configuration of a bridge 406. The illustrated bridge 406 can comprise integrated mounts 413. The integrated mounts 413 can be constructed in any of the manners described above. Advantageously, as described above, having an integrated mount improves the desirability of the construction from an aesthetic or cosmetic viewpoint because the integrated mount 413 can be generally hidden from view of casual observers of the eyewear.

Advantageously, in the constructions described above, two lenses are each formed with a viewing portion and two connecting portions that do not encroach into the viewing portion. One of the connecting portions is a temple connecting portion and one of the connecting portions is a bridge connecting portion. A bridge connects that bridge connecting portions and a temple extends from each of the temple connecting portions such that a single pair of rimless eyewear can be defined. In some embodiments, no hardware, screws, nuts, compression mounts, wires or other parts are installed within the viewing portion of the lenses. More particularly, in some preferred embodiments, the connecting portions for these components extends outwardly from a peripheral surface that defines the viewing portion and the connecting portions do not encroach into the viewing portion by interrupting that peripheral surface. In some embodiments, the bridge and/or the temples can be connected without any mechanical members and can be connected by adhesive, press fit, or other suitable construction.

Although the present invention has been disclosed in the context of certain preferred embodiments, examples and variations, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is specifically contemplated that various combinations or subcombinations of the specific features and aspects of the embodiments may be made and still fall within the scope of the invention. It should be understood that various features and aspects of the disclosed embodiments can be combined with or substituted for one another in order to form varying modes of the disclosed invention. Moreover, some variations that have been described with respect to one embodiment and not another embodiment can be used with such other embodiments. For instance, many of the embodiments feature reinforcing members. It is intended that the embodiments not featuring reinforcing members can use reinforcing members. Many other variations also have been described herein and cross-application is intended where physically possible. Moreover, it is anticipated that different assemblies can be used on the same eyewear or all assemblies can have a single construction. Thus, it is intended that the scope of the present invention herein disclosed should not be limited by the particular disclosed embodiments described above, but should be determined only by a fair reading of the claims that follow.

What is claimed is:

1. Eyewear comprising:
a first lens comprising a first bridge connecting portion, a first viewing portion and a first temple connecting portion, said first viewing portion comprising a first peripheral surface, said first bridge connecting portion extending outward from said first peripheral surface, said first temple connecting portion extending outward from said first peripheral surface, a first bore extending into said first temple connecting portion;
a second lens comprising a second bridge connecting portion, a second viewing portion and a second temple connecting portion, said second viewing portion comprising a second peripheral surface, said second bridge connecting portion extending outward from said second peripheral surface, said second temple connecting portion extending outward from said second peripheral surface, a second bore extending into said second temple connecting portion;
a bridge covering at least a portion of said first bridge connecting portion and being secured to said first bridge connecting portion and said bridge also covering at least a portion of said second bridge connecting portion and being secured to said second bridge connecting portion;
a first temple covering at least a portion of said first temple connecting portion and being secured to said first temple connecting portion by a first member that extends into said first bore; and
a second temple covering at least a portion of said second temple connecting portion and being secured to said second temple connecting portion by a second member that extends into said second bore.

2. The eyewear of claim 1, wherein said first bridge connecting portion, said first viewing portion and said first temple connecting portion are integrally formed.

3. The eyewear of claim 1, wherein said first bore extends fully through said first temple connecting portion.

4. The eyewear of claim 1, wherein said temple comprises a recess, said recess sized and configured to receive at least a portion of said temple connecting portion.

5. The eyewear of claim 4, wherein said recess is defined by three walls of said temple.

6. The eyewear of claim 5, wherein one of said three walls is a front wall.

7. The eyewear of claim 4, wherein said recess is defined by four walls.

8. The eyewear of claim 7, wherein one of said four walls is a front wall.

9. The eyewear of claim 1, wherein said first member comprises a u-shaped configuration.

10. The eyewear of claim 1, wherein said temple comprises a first opening, said first member extending through said first opening and into said first bore.

11. The eyewear of claim 10, wherein said first member has an outer diameter that is the same as or smaller than an inner diameter of said first opening of said first temple.

12. The eyewear of claim 1, wherein said first member is a pin.

13. The eyewear of claim 1, wherein said first member has an outer diameter that is smaller than an inner diameter of said first bore that extends into said first temple connecting member of said first lens.

14. The eyewear of claim 1, wherein said first temple comprises an end and said end of said first temple generally abuts said peripheral surface of said first lens.

15. The eyewear of claim 1 further comprising a first reinforcing member that is secured to said first temple mounting portion.

16. The eyewear of claim 15, wherein said first reinforcing member covers at least a portion of a surface of said first temple mounting portion that is not covered by said first temple.

17. The eyewear of claim 15, wherein said first reinforcing member comprises an opening and said first member extends through said opening of said first reinforcing member.

18. The eyewear of claim 15, wherein said first reinforcing member underlies at least a portion of said first temple.

19. Eyewear comprising a lens, said lens comprising a viewing portion and a connecting portion, said lens comprising a peripheral surface, said viewing portion of said lens being defined inside of said peripheral surface of said lens and said connecting portion of said lens being defined outside of said peripheral surface of said lens, said connecting portion of said lens comprising a mounting bore, an eyewear frame member covering at least a portion of said connecting portion of said lens but not said viewing portion of said lens and an eyewear frame connecting member extending from a portion of said eyewear frame member and into said mounting bore of said connecting portion of said lens such that said eyewear frame member is secured to said connecting portion of said lens by said eyewear frame connecting member.

20. The eyewear of claim 19, wherein said eyewear frame member comprises a temple.

21. The eyewear of claim 19, wherein said eyewear frame member comprises a bridge.

22. The eyewear of claim 19, wherein said mounting bore extends fully through said connecting portion of said lens.

23. The eyewear of claim 19, wherein said connecting portion of said lens has a generally consistent thickness.

24. The eyewear of claim 19, wherein said connecting portion of said lens curves such that said connecting portion of said lens continues a base curve of said lens.

25. The eyewear of claim 19, wherein said connecting portion of said lens does not follow a base curve of said lens.

26. The eyewear of claim 19, wherein said connecting portion of said lens is formed such that said connecting portion of said lens is generally perpendicular to an axis of a base curve of said lens.

27. The eyewear of claim 19, wherein said eyewear frame connecting member is integrally formed with a surface of said eyewear frame member.

28. The eyewear of claim 19, wherein said eyewear frame connecting member is integrally formed with an inner surface of said eyewear frame member.
